(19) United States
(12) Patent Application Publication
(10) Pub. No.: US 2009/0306320 A1
(43) Pub. Date: Dec. 10, 2009

(54) PHOTOCURING COMPOSITION AND CURED PRODUCT THEREOF

(75) Inventors: Takahito Miyamoto, Kusatsu-shi (JP); Masashi Sato, Toyokawa-shi (JP)

Correspondence Address: BUCHANAN, INGERSOLL & ROONEY PC, POST OFFICE BOX 1404, ALEXANDRIA, VA, 22313-1404, US

(73) Assignee: KONICA MINOLTA BUSINESS TECHNOLOGIES, INC., Chiyoda-ku (JP)

(21) Appl. No.: 12/332,443

(22) Filed: Dec. 11, 2008

(30) Foreign Application Priority Data
Jun. 9, 2008 (JP) 2008-150395

(51) Int. Cl. C08F 118/02; C08G 63/66

(52) U.S. Cl. 526/319; 528/361

(57) ABSTRACT

A photocuring composition, comprising a photoradically polymerizable compound and an ionically polymerizable compound having a surface energy smaller than that of the photoradically polymerizable compound, and a method of producing a cured product by using the composition thereof.

This application is based on application(s) No. 2008-150395 filed in Japan, the contents of which are hereby incorporated by reference.

### BACKGROUND OF THE INVENTION

1. Field of the Invention

The present invention relates to a photocuring composition, a method of producing a cured product by using the composition, and a cured product produced thereby.

2. Description of the Related Art

For example, photocuring adhesives, which have many advantages such as curability at room temperature, use of no solvent, fast curing velocity and favorable adhesiveness, have been used widely in various applications. In particular, as photo-radically polymerizable adhesives have a wide range for selecting its raw materials, various photocuring adhesives and various uses thereof have been proposed.

For example, photocuring adhesives in combination of a radically polymerizable material and a cationically polymerizable material were proposed for improvement in adhesiveness and sealing efficiency (e.g., Japanese Patent Application Laid-Open No. 05-117592), improvement in curing properties in the presence of a pigment (e.g., Japanese Patent Application Laid-Open No. 10-195117), prevention of curing shrinkage and control of water absorption (e.g., Japanese Patent Application Laid-Open No. 2006-307093).

However, curing of the radically polymerizable adhesives is inhibited by oxygen in air. In particular, a thin film is often cured insufficiently, resulting in a tacky cured surface.

For prevention of the adverse influences by oxygen in air, proposed were a method of using a radically polymerizable adhesive under nitrogen atmosphere (e.g., US 2005/0142292A1), a method of using a liquid composition immiscible with the photocuring composition at the interface with the air layer (e.g., Japanese Patent Application Laid-Open No. 08-231617), and a method of using a special photoinitiator or a wax (e.g., Japanese Patent Application Laid-Open No. 01-201652), but none of those techniques is not a blend of a radically polymerizable material and a cationically polymerizable material as in the present invention, and the solving methods in those techniques are different from that of the present invention.

An object of the present invention, which was made under the circumstances above, is to provide a photocuring composition that is sufficiently cured in the adhesion region in contact with air and not tacky on the cured surface even if a thin film thereof is formed, a method of producing a cured product by using the composition, and a cured product thereof.

The object can be achieved by blending a cationic polymerization adhesive satisfying a particular requirement with a photoradically polymerizable compound.

### SUMMARY OF THE INVENTION

The present invention relates to a photocuring composition, comprising a photoradically polymerizable compound and an ionically polymerizable compound having a surface energy smaller than that of the photoradically polymerizable compound and a photocured product, in which a photocuring composition containing a photoradically polymerizable compound and an ionically polymerizable compound having a surface energy smaller than that of the photoradically polymerizable compound is photocured.

### DETAILED DESCRIPTION OF THE INVENTION

The present invention provides a photocuring composition containing a photoradically polymerizable compound and an ionically polymerizable compound having a surface energy smaller than that of the photoradically polymerizable compound.

The photoradically polymerizable compound for use in the present invention is defined as a compound initiating polymerization by radicals generated by photoirradiation on a photoinitiator. Specifically, a monofunctional or multifunctional acrylate or methacrylate compound may be used.

Desirable is use of a photoradically polymerizable compound having a weight-average molecular weight (Mw) of 10,000 to 40,000, preferably approximately 13,000 to 37,000. Excessively larger molecular weight leads to deterioration in reactivity and processability because of decrease in the number of the functional groups therein, while excessively smaller molecular weight causes a problem of deterioration in storage stability.

In the present invention, the weight-average molecular weight (Mw) is a value determined by gel-permeation chromatography (GPC).

Commercially available examples of the adhesives of photoradically polymerizable compound for use in the present invention include WR-8120, WR-8125, WR-8839, WR-8840, WR-8833, WR-8830, WR-SK09 and WR-XVL90K (all manufactured by Kyoritsu Chemical & Co., Ltd.), GL2001 and GL2002 (all, manufactured by Gluelabo Ltd.), SA1000 and SA2000 (all, manufactured by Sony Chemicals Corporation), NOA71 (manufactured by NOLAND Com.), UVZ108E (manufactured by Zeon Corporation), and the like, which are all (meth)acrylic adhesives.

The ionically polymerizable compound used in combination with the radically polymerizable adhesive has a surface energy smaller than that of the photoradically polymerizable compound.

The ionically polymerizable compound for use in the present invention is defined as a compound initiating ionic polymerization by ions generated by photoirradiation on a photoinitiator, and examples thereof for use include monofunctional and multifunctional epoxy and vinylether compounds and the like. Among them, the ionically polymerizable compound favorably used in the present invention from the point of availability is an epoxy compound.

The ionically polymerizable compound for use preferably has a weight-average molecular weight of 300 to 10,000, preferably approximately 400 to 700. Unfavorably, excessively larger molecular weight leads to insufficient migration as will be described below, while excessively smaller molecular weight to deterioration in storage stability, and, if both the ionically and photoradically polymerizable compounds have smaller molecular weights, the composition has a problem of insufficient migration because of increase of compatibility between them.

The ionically polymerizable compound is used together with a photoinitiator. Examples of the photoinitiators include diazonium salts, onium salts, triarylsulfonium salts, benzoin tosylate, iron-arene complexes, and the like.

In the present invention, the “surface energy of a photoradically polymerizable compound” is expressed by the contact angle, as determined by applying the photoradically polymerizable compound containing an added photoinitiator on an aluminum plate to give a film thickness of 40 μm in air, curing the coated adhesive by photoirradiation with a high-pressure mercury lamp at an integrated light intensity of 6,000 mJ/cm², dropping a droplet of 1 to 2 μl of pure water on the cured surface, and thus, measuring the contact angle of the water to the cured film surface. The contact angle is an angle of the water droplet air surface to the cured film surface at the point of the water droplet surface in contact with the cured film surface. Larger contact angle means smaller surface energy.

In the present invention, the “surface energy of the ionically polymerizable compound” is expressed by the contact angle of water on the surface of the cured film of the ionically polymerizable compound, as determined similarly to the surface energy of the photoradically polymerizable compound, except that a mixture of the ionically polymerizable compound (100 wt parts) and a photoinitiator (2 wt parts) is used.

In the present invention, used is an ionically polymerizable compound having a surface energy smaller than that of the photoradically polymerizable compound. In this way, combined use of a photoradically polymerizable compound and an ionically polymerizable compound gives a photocuring composition that is sufficiently cured in the adhesion region in contact with air and not tacky on the cured surface even if a thin film is formed. It is because the photoradically polymerizable compound is polymerized without polymerization inhibition by oxygen, as the low-surface energy ionically polymerizable compound migrates toward the surface. The difference in surface energy is preferably 5 degrees or more by contact angle. If an ionically polymerizable compound having a surface energy not smaller than that of the photoradically polymerizable compound is used, the ionically polymerizable compound can not migrate toward the surface, resulting in that advantageous effects of the present invention can not be achieved.

The mixing ratio of the photoradically polymerizable compound to the ionically polymerizable compound is not particularly limited, but, the ratio of photoradically polymerizable compound/ionically polymerizable compound (by weight) is preferably 30/70 to 97/3, preferably 30/70 to 95/5. A photoradically polymerizable compound ratio of smaller than 30/70 leads to deterioration in water resistance and also to decrease in curing velocity. On the other hand, a photoradically polymerizable compound ratio of more than 97/3 leads to increased tackiness on the cured product surface and also some deterioration in curing properties.

A combination of the photoradically and ionically polymerizable compounds particularly favorable in the present invention is a (meth)acrylic radically polymerizable compound and an epoxy-based ionically polymerizable compound.

Other components may be added as needed to the photocuring composition according to the present invention in the range that does not impair the advantageous effects of the invention. For example, a pigment may be added to the photocuring composition according to the present invention when the composition is used as paint or ink, and a filler and others may be added thereto when it is used as a photosensitive resin for optical molding.

In using the photocuring composition according to the present invention, the composition after molding, for example by coating, is irradiated not immediately after coating but some time after application. The period for some time after application is aimed at segregation of the ionically polymerizable compound on the surface until formation of a layer resistant to polymerization inhibition by oxygen. The period to photoirradiation after application, which varies and should be selected properly according to the adhesive composition used, can be determined experimentally, by determining the period until the surface becomes not tacky (greasy) after the irradiation. It is normally 30 seconds to 20 minutes, more preferably 1 minute to 20 minutes, and particularly preferably approximately 1 minute to 5 minutes.

The photoirradiation is performed by using conventional photoirradiation means and methods, and, for example, a light at a wavelength of 200 to 400 nm is irradiated at an integrated light intensity of 2000 to 8000 mJ/cm².

The photocuring composition according to the present invention gives a cured product without tackiness on the cured surface even if it is produced in air environment containing oxygen.

### EXAMPLES

Radically and ionically polymerizable adhesives used in Examples and Comparative Examples are listed below. The radically polymerizable adhesive contains a photoradically polymerizable compound and a photoinitiator, and the ionically polymerizable adhesive contains an ionically polymerizable compound and a photoinitiator.

Radically Polymerizable Adhesives:

WR-XVL90K (manufactured by Kyoritsu Chemical & Co., Ltd.): (meth)acrylic compound,
WR-8839 (manufactured by Kyoritsu Chemical & Co., Ltd.): (meth)acrylic compound,
WR-SKO9 (manufactured by Kyoritsu Chemical & Co., Ltd.): (meth)acrylic compound, and
SKP32 (manufactured by Kyoritsu Chemical & Co., Ltd.): (meth)acrylic compound.

Ionically Polymerizable Adhesives:

WR08794 (manufactured by Kyoritsu Chemical & Co., Ltd.): epoxy-based compound, and
TB-3114 (manufactured by Three Bond Co., Ltd): epoxy-based compound.

Each of the photocuring compositions in Examples and Comparative Examples in the compositions shown in the following Table 1 was applied on an aluminum substrate to give a film thickness of 40 μm in air, and the coated adhesive was cured after 5 minutes by photoirradiation at an integrated light intensity of 6,000 mJ/cm² by using a high-pressure mercury lamp.

TABLE 1

| | Radically polymerizable adhesive | | | | Ionically polymerizable adhesive | | | | |
|---|---|---|---|---|---|---|---|---|---|
| | | Contact | Molecular | | | Contact | Molecular | | Evaluation |
| | | angle | weight | Parts by | | angle | weight | Parts by | of Curing |
| | Sample | (degree) | (Mw) | weight | Sample | (degree) | (Mw) | weight | Properties |
| Example 1 | 90K | 76.9 | 36000 | 97 | 8794 | 82 | 600 | 3 | ◯ |
| Example 2 | 90K | 76.9 | 36000 | 95 | 8794 | 82 | 600 | 5 | ⊚ |
| Example 3 | 90K | 76.9 | 36000 | 70 | 8794 | 82 | 600 | 30 | ⊚ |
| Example 4 | 90K | 76.9 | 36000 | 50 | 8794 | 82 | 600 | 50 | ⊚ |
| Example 5 | 90K | 76.9 | 36000 | 30 | 8794 | 82 | 600 | 70 | ⊚ |
| Example 6 | 90K | 76.9 | 36000 | 20 | 8794 | 82 | 600 | 80 | ⊚ |
| Example 7 | 90K | 76.9 | 36000 | 70 | 3114 | 83 | 427 | 30 | ⊚ |
| Example 8 | 8839 | 76.5 | 14000 | 95 | 3114 | 83 | 427 | 5 | ⊚ |
| Example 9 | 8839 | 76.5 | 14000 | 50 | 3114 | 83 | 427 | 50 | ⊚ |
| Example 10 | 8839 | 76.5 | 14000 | 30 | 3114 | 83 | 427 | 70 | ⊚ |
| Example 11 | 8839 | 76.5 | 14000 | 70 | 8794 | 82 | 600 | 30 | ⊚ |
| Example 12 | 8839 | 76.5 | 14000 | 20 | 3114 pre- | 83 | 20000 | 80 | ◯ |
| | | | | | crosslinked | | | | |
| Comparative | SK9 | 108 | 846 | 70 | 3114 | 83 | 427 | 30 | X |
| Example 1 | | | | | | | | | |
| Comparative | SK9 | 108 | 846 | 70 | 8794 | 82 | 600 | 30 | X |
| Example 2 | | | | | | | | | |
| Comparative | SKP32 | 84.3 | 2553 | 70 | 8794 | 82 | 600 | 30 | X |
| Example 3 | | | | | | | | | |
| Comparative | 8839 | 76.5 | 14000 | 100 | | | | | X |
| Example 4 | | | | | | | | | |
| Comparative | 90K | 76.9 | 36000 | 100 | | | | | X |
| Example 5 | | | | | | | | | |
| Comparative | SKP32 | 84.3 | 2553 | 100 | | | | | X |
| Example 6 | | | | | | | | | |
| Comparative | 8839 | 76.5 | 14000 | 100 | | | | | X |
| Example 7 | | | | | | | | | |

The cured product was left under normal-temperature environment for 2 hours, and the tackiness thereof was evaluated with finger and ranked as following:

⊚: Not tacky (greasy)
◯: Slightly tacky but not adhesive to finger

### x: Tacky.

The contact angle in Table 1, as determined by applying a radically or ionically polymerizable adhesive on an aluminum substrate to give a film thickness of 40 μm under air atmosphere, curing the coated adhesive by photoirradiation at an integrated light intensity of 6000 mJ/cm² by using a high-pressure mercury lamp, and measuring the contact angle of water on the cured film surface by using a contact angle analyzer (type CA-D) manufactured by Kyowa Interface Science Co., Ltd, was used as an alternative for surface energy.

The molecular weight in Table 1 is a value obtained by gel-permeation chromatography (GPC).

A cured product prepared in a similar manner to Example 1, except the photoirradiation was performed immediately after application of the photocuring composition, was evaluated, showing that it was tacky.

### INDUSTRIAL APPLICABILITY

The photocuring composition according to the present invention can be used in various applications such as photocuring paint, adhesive, ink, and optically-molding photosensitive resin.

What is claimed is:

1. A photocuring composition, comprising a photoradically polymerizable compound and an ionically polymerizable compound having a surface energy smaller than that of the photoradically polymerizable compound.

2. The photocuring composition of claim 1, in which the photoradically polymerizable compound has a weight-average molecular weight of 10,000 to 40,000.

3. The photocuring composition of claim 1, in which the ionically polymerizable compound has a weight-average molecular weight of 300 to 10,000.

4. The photocuring composition of claim 1, in which the difference of surface energy between the photoradically polymerizable compound and the ionically polymerizable compound is 5 degrees or more by contact angle.

5. The photocuring composition of claim 1, in which a ratio of photoradically polymerizable compound/ionically polymerizable compound is 30/70 to 97/3 by weight.

6. A photocured product, in which a photocuring composition containing a photoradically polymerizable compound and an ionically polymerizable compound having a surface energy smaller than that of the photoradically polymerizable compound is photocured.

7. The photocured product of claim 6, in which the photoradically polymerizable compound has a weight-average molecular weight of 10,000 to 40,000.

8. The photocured product of claim 6, in which the ionically polymerizable compound has a weight-average molecular weight of 300 to 10,000.

9. The photocured product of claim 6, in which the difference of surface energy between the photoradically polymerizable compound and the ionically polymerizable compound is 5 degrees or more by contact angle.

10. The photocured product of claim 6, in which a ratio of photoradically polymerizable compound/ionically polymerizable compound is 30/70 to 97/3 by weight.
